(19) United States
(12) Patent Application Publication
(10) Pub. No.: US 2014/0332466 A1
(43) Pub. Date: Nov. 13, 2014

(54) Liquid-Liquid Contacting Tray With Concentric Inlet And Outlet Weirs

(71) Applicants: Jonathan A. Tertel, Mt. Prospect, IL (US); Ronald M. Gatan, Chicago, IL (US)

(72) Inventors: Jonathan A. Tertel, Mt. Prospect, IL (US); Ronald M. Gatan, Chicago, IL (US)

(21) Appl. No.: 13/889,962

(22) Filed: May 8, 2013

(51) Int. Cl. B01D 11/04

(52) U.S. Cl. CPC B01D 11/04
USPC 210/634; 210/511

(57) ABSTRACT

Disclosed is a liquid-liquid contacting tray, including: (i) a liquid-liquid contacting deck having a first side and a opposite second side, the deck comprising a perforated tray material; (ii) an outlet weir extending vertically from the first side of the contacting deck, the outlet weir defining an interior space of the outlet weir; (iii) an inlet weir extending vertically from the first side of the contacting deck, the inlet weir surrounding the outlet weir; and (iv) a tubular downcomer having a first end and a second end, the first end being in fluid communication with the interior space of the outlet weir, the downcomer extending away from the second side of the liquid-liquid contacting deck.

### CROSS-REFERENCES TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The disclosure relates to a liquid-liquid contacting device and in particular to an improved tray design for a multiple stage column for contacting a liquid with a fluid that is substantially immiscible therewith at prevailing conditions.

2. Description of the Related Art

Liquid-liquid extraction is a method for separation of a compound dissolved in a first liquid phase by contacting the first liquid phase with a, preferably immiscible, second liquid phase. The second liquid phase is chosen such that the compound to be recovered preferentially partitions into the second liquid phase. Liquid-liquid extraction is often employed to remove an undesirable compound from a liquid or to facilitate separation and purification of a desired compound where recovery from the initial solution is difficult.

In the oil refining industry, it is conventional practice at the present time to treat sour hydrocarbon and gas streams to remove mercaptans. Extraction processes are typically used when treating light hydrocarbons and gas streams for mercaptan removal. Mercaptans have traditionally been removed from hydrocarbon streams because of their malodorous scent.

In one example of a liquid-liquid extraction process, mercaptides are removed from the hydrocarbon stream not to be returned. In a typical extraction process, a liquid hydrocarbon stream is fed to an amine absorber column to be contacted with an amine, such as diethanolamine, to absorb acid gases such as hydrogen sulfide and carbon dioxide from the hydrocarbon stream. The hydrocarbon stream lean of hydrogen sulfide and other acid gases is then sent on for further processing.

Liquid-liquid extraction can be a batch process or a continuous process with either approach carried out over one or more extraction stages. Multi-stage liquid-liquid extraction processes can involve counter-current mixing of the two liquid phases with the mixing process facilitated by a number of trays which define the stages. The design of these trays is critical to achieving proper separation as they promote emulsification to produce droplets of one liquid phase in the other, extraction to cause a solute dissolved in one of the two phases to migrate to the other phase, and separation to aggregate the droplets and separate the two phases. Furthermore, the design of the tray must interface properly with the extraction vessel to prevent the liquid phases from flowing in an undesirable manner. For example, if components of a tray contact the vessel wall, they must be sealed so that they do not allow liquid to leak through them in order to have proper operation of the column.

Amine absorbers and mercaptan oxidation extractors are often post-weld heat treated. In a situation where trays are connected to the vessel wall, if the connection is not made liquid tight prior to the vessel installation, it is very difficult to repair afterwards due to the post-weld heat treatment. This can lead to delays in start up of the units, and lower extraction efficiencies, or even the inability of the trayed column to perform properly at design rates.

What is needed therefore is an improved liquid-liquid contacting device and in particular to an improved tray design for a multiple stage column for contacting a liquid with a fluid that is substantially immiscible therewith.

### SUMMARY OF THE INVENTION

The foregoing needs are met by a liquid-liquid contacting tray that includes (i) a liquid-liquid contacting deck having a first side and a opposite second side wherein the deck comprises a perforated tray material; (ii) an outlet weir extending vertically from the first side of the contacting deck wherein the outlet weir defines an interior space of the outlet weir, (iii) an inlet weir extending vertically from the first side of the contacting deck, the inlet weir surrounding the outlet weir; and (iv) a tubular downcomer having a first end and a second end; the first end being in fluid communication with the interior space of the outlet weir, and the downcomer extending away from the second side of the liquid-liquid contacting deck.

In one form, the inlet weir and the outlet weir are concentric, the inlet weir and the outlet weir are cylindrical, and the inlet weir and the outlet weir extend substantially perpendicularly from the first side of the deck. The second end of the downcomer can be in fluid communication with the first side of a second, subjacent liquid-liquid contacting deck.

In one form, the deck is perforated between the inlet weir and the outlet weir, and a section of the deck outward from the inlet weir is imperforate.

In one form, the outlet weir can extends away from the first side and the second side of the deck.

The foregoing needs are also met by a material extraction vessel including an outer wall defining an inner space of the vessel, and a liquid-liquid contacting tray arranged in the inner space of the vessel. The liquid-liquid contacting tray includes (i) a liquid-liquid contacting deck having a first side and a opposite second side wherein the deck comprises a perforated tray material, (ii) an outlet weir extending vertically from the first side of the contacting deck wherein the outlet weir defines an interior space of the outlet weir, (iii) an inlet weir extending vertically from the first side of the contacting deck wherein the inlet weir surrounds the outlet weir, and (iv) a tubular downcomer having a first end in fluid communication with the interior space of the outlet weir wherein the downcomer extends away from the second side of the liquid-liquid contacting deck. The outlet weir extends away from the first side and the second side of the deck.

In one form, the vessel includes a base tray arranged in the inner space of the vessel subjacent to the liquid-liquid contacting tray, and the tubular downcomer has a second end in fluid communication with the base tray. The base tray can include (i) a feed deck, (ii) a feed deck outlet weir extending vertically from a first side of the feed deck wherein the feed deck outlet weir defines an interior space of the feed deck outlet weir, and (iii) a feed deck inlet weir extending vertically from the first side of the feed deck wherein the feed deck inlet weir surrounds the feed deck outlet weir. The second end of the tubular downcomer is in fluid communication with a section of the feed deck outward from the feed deck inlet weir.

The inlet weir and the outlet weir can be concentric, and the inlet weir and the outlet weir can be cylindrical. The inlet weir and the outlet weir can extend substantially perpendicularly from the first side of the deck.

In one form, the deck is perforated between the inlet weir and the outlet weir, and a section of the deck outward from the inlet weir is imperforate.

The vessel can further include a flange extending inward from the outer wall such that the flange contacts the second side of the a liquid-liquid contacting tray.

The vessel can further include one or more additional liquid-liquid contacting trays arranged in the inner space of the vessel. Each additional liquid-liquid contacting tray may include: (i) a liquid-liquid contacting deck having a first side and a opposite second side wherein the deck comprises a perforated tray material, (ii) an outlet weir extending vertically from the first side of the contacting deck wherein the outlet weir defines an interior space of the outlet weir, (iii) an inlet weir extending vertically from the first side of the contacting deck wherein the inlet weir surrounds the outlet weir, and (iv) a tubular downcomer having a first end in fluid communication with the interior space of the outlet weir wherein the downcomer extends away from the second side of the liquid-liquid contacting deck, and the tubular downcomer has a second end in fluid communication with a subjacent tray. Preferably, the liquid-liquid contacting trays are arranged in a vertical stack.

The foregoing needs are also met by a process for extracting a material from a first liquid phase. The process uses a vessel including an outer wall defining an inner space of the vessel and a liquid-liquid contacting tray arranged in the inner space of the vessel. The liquid-liquid contacting tray includes: (i) a liquid-liquid contacting deck having a first side and a opposite second side wherein the deck comprises a perforated tray material, (ii) an outlet weir extending vertically from the first side of the contacting deck wherein the outlet weir defines an interior space of the outlet weir, and (iii) an inlet weir extending vertically from the first side of the contacting deck wherein the inlet weir surrounds the outlet weir. In the process the first liquid phase is contacted with a second liquid phase on the liquid-liquid contacting deck. In the vessel used in the process, the inlet weir and the outlet weir can be concentric, the inlet weir and the outlet weir can be cylindrical, the deck can be perforated between the inlet weir and the outlet weir, and a section of the deck outward from the inlet weir can be imperforate.

It is therefore an advantage of the invention to provide an improved liquid-liquid contacting tray design comprising circular concentric inlet and outlet fluid flow baffles, commonly referred to as weirs, to improve the overall extraction process.

It is another advantage of the invention to provide an improved liquid-liquid tray interface with the extraction vessel in order to avoid the need for the weirs to form a liquid impermeable seal with the vessel wall.

These and other features, aspects, and advantages of the present invention will become better understood upon consideration of the following detailed description, drawings and appended claims.

### BRIEF DESCRIPTION OF THE DRAWINGS

FIG. 1 is a process flow scheme for the process of the present invention.

FIG. 2 is a cross-section taken along line 2-2 of FIG. 1 depicting a detailed schematic of the extraction vessel of FIG. 1.

FIG. 3 is a cross-section taken along the line 3-3 of FIG. 2 depicting a top-down view of the liquid-liquid contacting tray.

FIG. 4 is a cross-section taken along the line 4-4 of FIG. 2 depicting a top-down view of the base tray.

Like reference numerals will be used to refer to like parts from Figure to Figure in the following description of the drawings.

### DETAILED DESCRIPTION OF THE INVENTION

A general understanding of the process and apparatus of this invention can be obtained by reference to the Figures. The Figures have been simplified by the deletion of a large number of apparatuses customarily employed in a process of this nature, such as vessel internals, temperature and pressure controls systems, flow control valves, recycle pumps, etc. which are not specifically required to illustrate the performance of the invention. Furthermore, the illustration of the process of this invention in the embodiment of a specific drawing is not intended to limit the invention to specific embodiments set out herein. Lastly, although a process for extraction of hydrogen sulfide and various mercaptans is illustrated by way of an example, other liquid-liquid extraction schemes are contemplated.

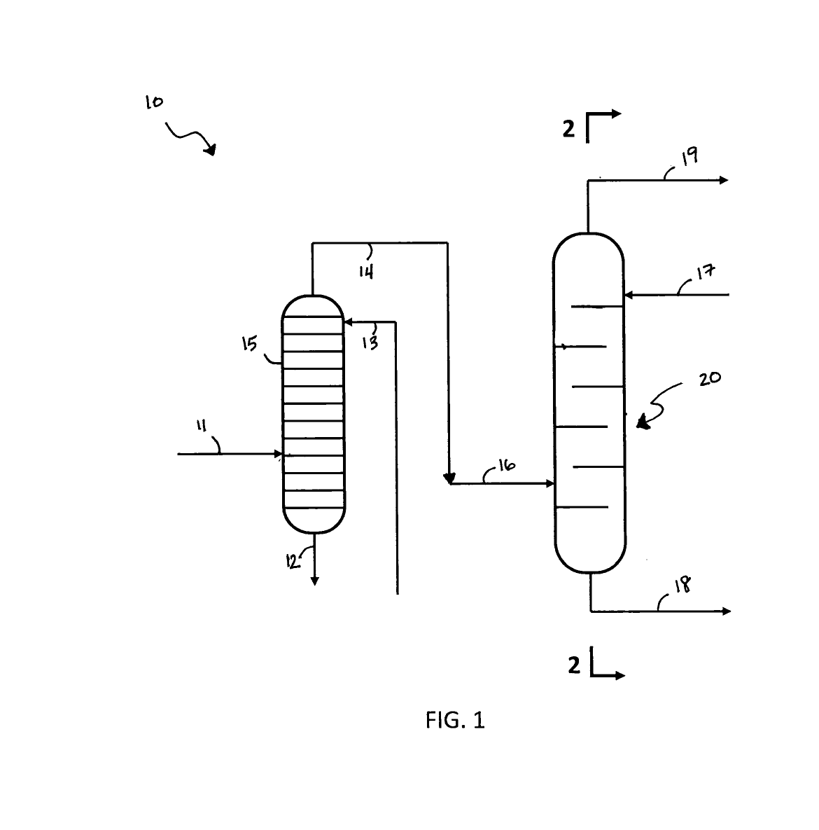

In order to provide context for the present invention, FIG. 1 illustrates a unit operation 10 for the extraction of sulfur compounds from a liquefied petroleum gas (LPG) stream. Referring to FIG. 1, a hydrocarbon liquid stream such as LPG or naphtha containing mercaptan sulfur and hydrogen sulfide is fed through a line 11 to an amine absorber vessel 15. Amines such as diethanolamine or monoethanolamine are fed to the amine absorber vessel 15 through a line 13. The amine absorber vessel 15 contains a series of liquid-liquid contacting trays. The line 11 delivering the hydrocarbon stream has a distributor that is below the mid-point and typically directly above the bottom tray of the vessel 15. A nozzle on the line 13 for delivering the amines is disposed toward the top of the vessel and typically directly above the top tray behind the inlet weir to allow counter-current contact of the amines descending in the vessel and the hydrocarbon ascending through the vessel 15. The amines in the vessel 15 react with hydrogen sulfide to yield thiolamides. Typically, a hydrocarbon stream containing approximately 1,000 to 2,000 and up to 10,000 wppm of hydrogen sulfide is reduced down to 15 wppm of hydrogen sulfide concentration in the amine absorber vessel 15. An amine effluent stream rich in thiolamides exits the bottom of the amine absorber vessel 15 through a line 12 while the hydrocarbon effluent stream exits the top of the amine absorber vessel 15 through a line 14 with a substantially reduced concentration of hydrogen sulfide. Additionally, carbon dioxide or other acid gases that are possibly present in the feed stream in the line 11 also react with the amines and are absorbed into the amine effluent stream leaving the amine absorber vessel 15 through the line 12.

The hydrocarbon effluent from the amine absorber vessel 15 undergoes a preliminary caustic prewash step before undergoing the main extraction in a extraction vessel 20 through the line 16. Rich caustic is withdrawn from the extraction vessel 20 through a line 18. Fresh or regenerated caustic in a line 17 is continuously fed to the extraction vessel 20. Mercaptans in the extraction vessel 20 react with the caustic to yield sodium mercaptides and water. The lower density hydrocarbons rise to the top of the extraction vessel 20 while the aqueous caustic and mercaptides dissolved in the aqueous caustic sink to the bottom of the extraction vessel 20. Treated hydrocarbon substantially devoid of mercaptans and mercaptides exits the extraction vessel 20 via a product conduit 19. Rich caustic rich in mercaptides is withdrawn through a line 18.

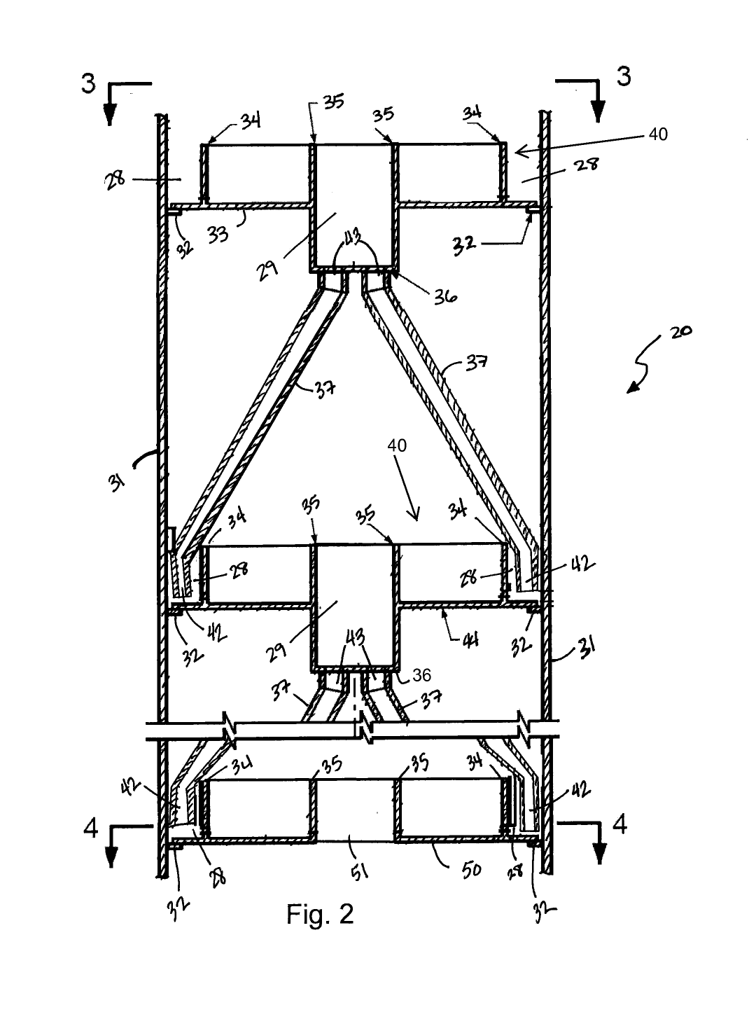

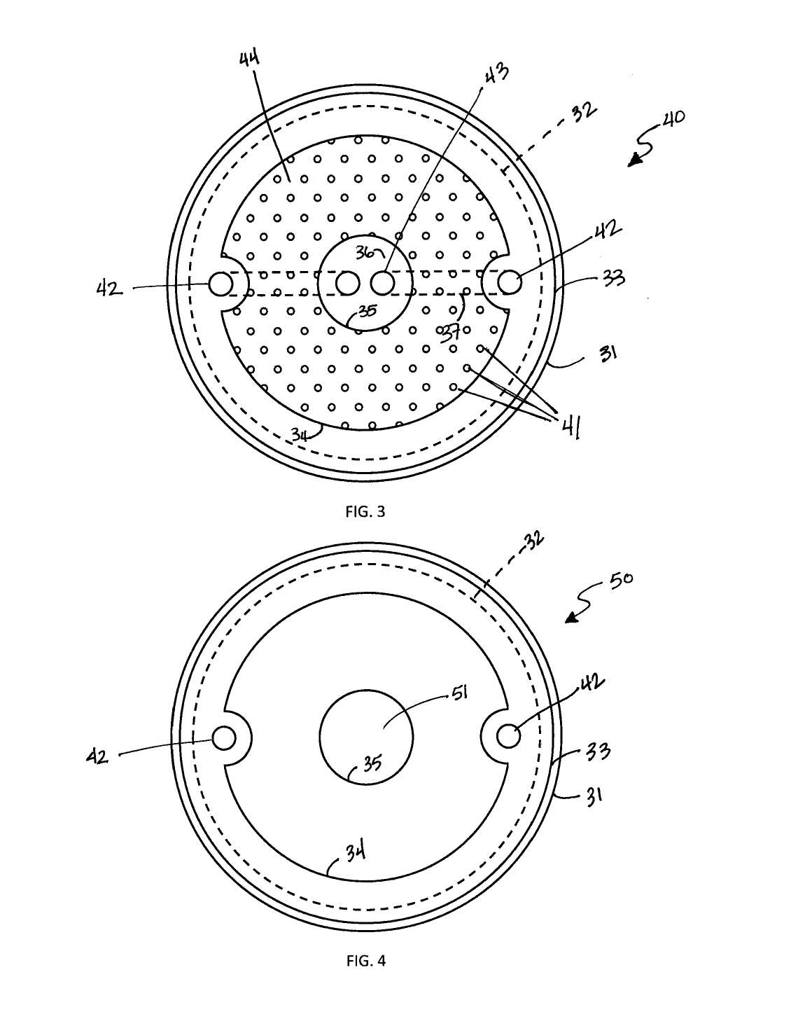

FIG. 2 shows the internals of an extraction vessel 20 according to the invention in greater detail. The extraction vessel 20 contains a plurality of liquid-liquid contacting trays 40 alternatively known as jet decks supported by inwardly directed flanges 32 positioned along the interior of the extraction vessel 20. FIGS. 2-4 will be referenced to describe the liquid-liquid contacting trays 40, which are typically formed from stainless steel or carbon steel. Each of the liquid-liquid contacting trays comprises a horizontal deck 33 that extends partially across the cross-sectional area of the extraction vessel 20, an upstanding inlet weir 34, and upstanding outlet weir 35. The inlet weir 34 and the outlet weir 35 are concentric and cylindrical in the embodiment shown; however, the inlet weir 34 and the outlet weir 35 may have other shapes such as oval, ellipse or polygonal (e.g., rectangle, square).

Suitably, two to fifteen decks can be used in an extractor section, and six to ten decks are typical. Preferably, the decks 33 are positioned a distance of about 2 feet (0.6 meters) to about 10 feet (3.0 meters) apart, and more preferably about 5 feet (1.5 meters) to about 7 feet (2.1 meters) apart.

The caustic enters an inlet space 28 defined by the inlet weir 34, the deck 33 and the inner surface of the wall 31 of the extraction vessel 20. The liquid-liquid contacting trays 40 include downcomers 37 having an outlet 42 disposed in the inlet space 28 of a subjacent liquid-liquid contacting tray 40. Preferably, 1 to 4 downcomers 37 are used for each tray 40. Preferably, the downcomers 37 have an inside diameter in the range of 2 inches to 24 inches. Each liquid-liquid contacting tray 40 further comprises an outlet space 29 defined by the outlet weir 35 and a horizontal end wall 36, which communicates with an inlet 43 of each downcomer 37. The deck 33 of the liquid-liquid contacting tray 40 further comprises a perforate sieve section 44 defined by the space between the inlet weir 34 and the outlet weir 35 and an imperforate section defined by the aforementioned inlet space 28; the imperforate section separated from the sieve section 44 by inlet weir 34. Preferably the perforations are located at a triangular pitch of about 3 inches (7.62 cm.) to about 6 inches (15.24 cm.) apart. Fresh or regenerated caustic from the line 17 in FIG. 1 is fed to the inlet space of the topmost liquid-liquid contacting tray 40.

The height of the weirs 34 and 35 are about 1 foot (30.5 cm) so when caustic exceeds 1 foot (30.5 cm) in depth, it spills over the respective weir. In the case of the base tray 50, caustic spilling over the outlet weir 35 into the feed deck outlet 51 spills down to a caustic-hydrocarbon interface (not shown) below the base tray 50. In the case of each of the other liquid-liquid contacting trays 40, caustic spilling over the inlet weir 34 flows onto the sieve section 44 to contact hydrocarbon ascending through perforations 41 in the sieve section 44. Caustic that makes it way into the outlet space 29 of the liquid-liquid contacting trays 40 proceeds through the inlet 43 of the first end of the downcomers 37 down into the inlet space 28 of the subjacent liquid-liquid contacting tray 40 or base tray 50, through the outlet 42 at the second end of the downcomer 37. This arrangement assures adequate contact between the hydrocarbon and the caustic while the hydrocarbon rises to the top of the extraction vessel 20 and out through the product conduit 19.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A liquid-liquid contacting tray comprising:
a liquid-liquid contacting deck having a first side and a opposite second side, the deck comprising a perforated tray material;
an outlet weir extending vertically from the first side of the contacting deck, the outlet weir defining an interior space of the outlet weir;
an inlet weir extending vertically from the first side of the contacting deck, the inlet weir surrounding the outlet weir; and
a tubular downcomer having a first end and a second end; the first end being in fluid communication with the interior space of the outlet weir, the downcomer extending away from the second side of the liquid-liquid contacting deck.

2. The liquid-liquid contacting tray of claim 1, wherein the inlet weir and the outlet weir are concentric.

3. The liquid-liquid contacting tray of claim 1, wherein the inlet weir and the outlet weir are cylindrical.

4. The liquid-liquid contacting tray of claim 1, wherein the inlet weir and the outlet weir extend substantially perpendicularly from the first side of the deck.

5. The liquid-liquid contacting tray of claim 1, wherein the second end of the downcomer is in fluid communication with the first side of a second, subjacent liquid-liquid contacting deck.

6. The liquid-liquid contacting tray of claim 1, wherein the deck is perforated between the inlet weir and the outlet weir.

7. The liquid-liquid contacting tray of claim 1, wherein a section of the deck outward from the inlet weir is imperforate.

8. The liquid-liquid contacting tray of claim 1, wherein:
the outlet weir extends away from the first side and the second side of the deck.

9. A vessel for extracting a material, the vessel comprising:
an outer wall defining an inner space of the vessel; and
a liquid-liquid contacting tray arranged in the inner space of the vessel, the liquid-liquid contacting tray comprising: (i) a liquid-liquid contacting deck having a first side and a opposite second side, the deck comprising a perforated tray material, (ii) an outlet weir extending vertically from the first side of the contacting deck, the outlet weir defining an interior space of the outlet weir, (iii) an inlet weir extending vertically from the first side of the contacting deck, the inlet weir surrounding the outlet weir, and (iv) a tubular downcomer having a first end in fluid communication with the interior space of the outlet weir, the downcomer extending away from the second side of the liquid-liquid contacting deck.

10. The vessel of claim 9 further comprising:
a base tray arranged in the inner space of the vessel subjacent to the liquid-liquid contacting tray, the tubular downcomer having a second end in fluid communication with the base tray.

11. The vessel of claim 10 wherein:
the base tray includes (i) a feed deck, (ii) a feed deck outlet weir extending vertically from a first side of the feed deck, the feed deck outlet weir defining an interior space of the feed deck outlet weir, and (iii) a feed deck inlet weir extending vertically from the first side of the feed deck, the feed deck inlet weir surrounding the feed deck outlet weir, and
the second end of the tubular downcomer is in fluid communication with a section of the feed deck outward from the feed deck inlet weir.

12. The vessel of claim 9, wherein:
the inlet weir and the outlet weir are concentric, and
the inlet weir and the outlet weir are cylindrical.

13. The vessel of claim 9, wherein the inlet weir and the outlet weir extend substantially perpendicularly from the first side of the deck.

14. The vessel of claim 9, wherein:
the deck is perforated between the inlet weir and the outlet weir, and
a section of the deck outward from the inlet weir is imperforate.

15. The vessel of claim 9 further comprising a flange extending inward from the outer wall, the flange contacting the second side of the a liquid-liquid contacting tray.

16. The vessel of claim 9 wherein the outlet weir extends away from the first side and the second side of the deck.

17. The vessel of claim 9, further comprising one or more additional liquid-liquid contacting trays arranged in the inner space of the vessel, each additional liquid-liquid contacting tray comprising: (i) a liquid-liquid contacting deck having a first side and a opposite second side, the deck comprising a perforated tray material, (ii) an outlet weir extending vertically from the first side of the contacting deck, the outlet weir defining an interior space of the outlet weir, (iii) an inlet weir extending vertically from the first side of the contacting deck, the inlet weir surrounding the outlet weir, and (iv) a tubular downcomer having a first end in fluid communication with the interior space of the outlet weir, the downcomer extending away from the second side of the liquid-liquid contacting deck, and the tubular downcomer having a second end in fluid communication with a subjacent tray.

18. The vessel of claim 17, wherein the liquid-liquid contacting tray and each of the additional liquid-liquid contacting trays are arranged in a vertical stack.

19. A process for extracting a material from a first liquid phase, the process comprising:
(a) providing a vessel including an outer wall defining an inner space of the vessel and a liquid-liquid contacting tray arranged in the inner space of the vessel, the liquid-liquid contacting tray comprising: (i) a liquid-liquid contacting deck having a first side and a opposite second side, the deck comprising a perforated tray material, (ii) an outlet weir extending vertically from the first side of the contacting deck, the outlet weir defining an interior space of the outlet weir, and (iii) an inlet weir extending vertically from the first side of the contacting deck, the inlet weir surrounding the outlet weir; and
(b) contacting the first liquid phase with a second liquid phase on the liquid-liquid contacting deck.

20. The process of claim 19 wherein:
the inlet weir and the outlet weir are concentric,
the inlet weir and the outlet weir are cylindrical,
the deck is perforated between the inlet weir and the outlet weir, and
a section of the deck outward from the inlet weir is imperforate.
